(19) United States
(12) Patent Application Publication
(10) Pub. No.: US 2005/0237919 A1
(43) Pub. Date: Oct. 27, 2005

(54) Generation of orthogonal codes

(76) Inventors: Hartmut Pettendorf, Forchheim (DE); Paul Faulhaber, Oberpleichfeld (DE)

Correspondence Address: ERICSSON INC., 6300 LEGACY DRIVE, M/S EVR C11, PLANO, TX, 75024, US

(21) Appl. No.: 10/517,462

(22) PCT Filed: Jun. 21, 2002
(86) PCT No.: PCT/EP02/06872

§ 371 Date: Jun. 8, 2005

(51) Int. Cl. H04J 11/00

(52) U.S. Cl. 370/208; 370/310

(57) ABSTRACT

A code generator and method for generating an orthogonal code for use in the baseband part of a transmitter or transceiver of a telecommunication system. An index conversion unit converts an index (k) into a modified index (j) associated with a corresponding code having a spreading factor greater than one and less than or equal to a maximum spreading factor. A logic unit performs logic operations on bits of the modified index (j) and a counter value (i) to generate a code bit of the orthogonal code. A number of parallel code generators may generate a number of orthogonal codes having respective spreading factors and indices.

### FIELD OF THE INVENTION

The present invention relates to the generation of orthogonal codes such as “orthogonal variable spreading factor” (OVSF) codes, Hadamard-codes, Walsh codes etc. . . . More particularly, the present invention relates to improved code generation apparati and methods for application in, e.g., the baseband part of a transmitter or a transceiver of a telecommunication system.

### DESCRIPTION OF THE PRIOR ART

A transmitter for use in a digital telecommunication system is known, for instance, from 3GPP TS 25.212 V3.4.0 (September 2000) “3rd Generation Partnership Project; Technical Specification Group Radio Access Network; Multiplexing and channel coding (FDD) (Release 1999)”, section 4.2. In FIG. 1 of the present application, a block diagram of parts of such a transmitter is given. As shown, the transmitter includes a channel encoder, a rate matcher, an interleaver, and a (baseband) modulator, wherein the latter converts the interleaved data bits into symbols which, in general, are complex-valued. Further components dedicated to digital-to-analog conversion, pulse shaping, frequency up-conversion and amplification are omitted for conciseness reasons. Finally, a signal is transmitted over the physical channel, i.e. the air interface, a wireline etc. . . .

The channel encoding scheme(s), the rate matching scheme(s), the interleaving scheme(s), and the modulation scheme(s) are specified in detail by the communication standard according to which the telecommunication system is to be operated. In the area of third generation (3G) mobile communications, an important standard is referred to as WCDMA/UMTS (wideband code division multiple access/universal mobile telecommunication system).

In direct-sequence spread spectrum (DSSS) systems such as WCDMA/UMTS systems, the data bit sequence to be transmitted is spread in the modulator (which therefore is also referred to as spreader) with a pseudo-noise (PN) sequence having a higher rate. This is achieved by XORing the binary 0/1-representations of the data bit sequence and the PN sequence, or equivalently, by multiplying the antipodal binary (±1) representations of said sequences, wherein the values of zero and one correspond to “+1” and “−1”, respectively, in antipodal notation.

In order to qualify for an application in DSSS systems, the PN sequences must meet certain requirements. For example, each PN sequence (code) must reveal a sharp auto-correlation peak in order to enable code synchronization, while different PN sequences must have low cross-correlation values in order to facilitate detection of a signal spread with a particular PN sequence in an additive mixture of signals spread with different PN sequences. Furthermore, the PN sequences should be balanced, i.e. the difference in the number of ones and the number of zeros in a given PN sequence should at most be equal to one.

In state-of-the-art DSSS systems, the following PN sequences can be found: Walsh codes, Hadamard codes, M-sequences, Gold codes, Kasami codes etc. . . .

The PN sequences can be subdivided into two classes: orthogonal and non-orthogonal sequences. The present invention relates to the class of orthogonal sequences. For example, “orthogonal variable spreading factor” (OVSF) codes fall into this class. OVSF codes do have good auto-correlation and cross-correlation properties and are also balanced in the sense described above. Moreover, they are mutually orthogonal.

OVSF codes can be depicted in the form of a code tree, as shown in FIG. 2a. Herein, each level of the code tree defines a set of OVSF codes each having a length corresponding to the so-called “spreading factor” SF, wherein SF=2ⁿ with n=0, 1, 2, . . . . In each level, there are SF different codes, also referred to as codewords. Every branch (horizontal line of the tree) is dedicated to one codeword C_{OVSF, SF, k} uniquely identified by the spreading factor SF and an index k in the range 0, 1, . . . , SF-1.

A generation method for the generation of OVSF codes is known from 3GPP TS 25.213 V3.6.0 (June 2001) “3rd Generation Partnership Project; Technical Specification Group Radio Access Network; Spreading and modulation (FDD) (Release 1999)”, section 4.3.1.1. According to this document, the generation method is defined recursively by the following equations:

$${C}_{OVSF .1 .0} = 1 , \\ [ \begin{matrix}{C}_{OVSF , 2 , 0} \\ {C}_{OVSF {,}_{2 , 1}}\end{matrix} ] = [ \begin{matrix}{C}_{OVSF {,}_{1 , 0}} & {C}_{OVSF {,}_{1 , 0}} \\ {C}_{OVSF {,}_{1 , 0}} & - {C}_{OVSF {,}_{1 , 0}}\end{matrix} ] = [ \begin{matrix}1 & 1 \\ 1 & - 1\end{matrix} ] \\ [ \begin{matrix}{C}_{OVSF {,}_{{2}^{( n + 1 )} , 0}} \\ {C}_{OVSF {,}_{{2}^{( n + 1 )} , 1}} \\ {C}_{OVSF {,}_{{2}^{( n + 1 )} , 2}} \\ {C}_{OVSF {,}_{{2}^{( n + 1 )} , 3}} \\ ⋮ \\ {C}_{OVSF {,}_{{2}^{( n + 1 )} , {2}^{( n + 1 )} - 2}} \\ {C}_{OVSF {,}_{{2}^{( n + 1 )} , {2}^{( n + 1} - 1}}\end{matrix} ] = [ \begin{matrix}{C}_{OVSF {,}_{{2}^{n} , 0}} & {C}_{OVSF {,}_{{2}^{n} , 0}} \\ {C}_{OVSF {,}_{{2}^{n} , 0}} & - {C}_{OVSF {,}_{{2}^{n} , 0}} \\ {C}_{OVSF {,}_{{2}^{n} , 1}} & {C}_{OVSF {,}_{{2}^{n} , 1}} \\ {C}_{OVSF {,}_{{2}^{n} , 1}} & - {C}_{OVSF {,}_{{2}^{n} , 1}} \\ ⋮ & ⋮ \\ {C}_{OVSF {,}_{{2}^{n} , {2}^{n} - 1}} & {C}_{OVSF {,}_{{2}^{n} , {2}^{n} - 1}} \\ {C}_{OVSF {,}_{{2}^{n} , {2}^{n} - 1}} & - {C}_{OVSF {,}_{{2}^{n} , {2}^{n} - 1}}\end{matrix} ] .$$

Herein, the first equation relates to the trivial case of SF=1. In addition, the first equation provides the initial condition for the second equation given in matrix notation, according to which the two codewords for SF=2 can be determined from the SF=1 codeword in the following way. For the first codeword (index k=0, first line of the matrices in the second equation), the non-inverted SF=1 codeword (i.e. “1”) is appended to the SF=1 codeword itself thus producing “1, 1”, while for the second codeword (k=1, second line of matrices), the inverted SF=1 codeword (“−1”) is appended thus producing “1, −1”. For higher spreading factors SF=2ⁿ, the third equation provides the general recursive formula which in general holds for n=0, 1, 2, . . . . The leftmost value in each codeword usually corresponds to the code bit of the codeword which is normally transmitted first in time.

As the skilled person will readily appreciate, Walsh codes and Hadamard codes are also orthogonal. More particularly, they differ from OVSF codes only in so far as they are indexed in a different manner, while for any given spreading factor SF, the same SF codes (codewords) form part of the set of codes. In other words, the codewords are only arranged in a different order depending on whether it is an OVSF, Walsh or Hadamard set of codes. As an example, FIG. 2b shows the relation of the OVSF and Hadamard codes having a spreading factor of SF=16. While the 16 different codes (codewords) are indicated in the third column of the table in FIG. 2b, the OVSF and Hadamard indices k are provided in decimal and binary notation in the first (OVSF) and second (Hadamard) column, respectively. For example, it can be seen from the third line of the table that the OVSF code with decimal index 2 corresponds to (i.e., is identical to) the Hadamard code with decimal index 4, i.e.
C_{OVSF, 16, 2}=C_{Had, 16, 4}.
Depending on the generation method used to calculate the Walsh codes, a similar table applies to Walsh codes.

As the skilled person will appreciate, a straight-forward approach to generating such codes consists in a combined software/hardware solution, wherein codewords are generated by a DSP in accordance with a program. For example, in an initial pre-transmission phase, i.e. “off-line”, the desired codeword, i.e. the codeword having a particular spreading factor SF and a particular index k could be calculated by the DSP and stored in a dual-port RAM. In a subsequent transmission phase, i.e. “on-line”, the stored codeword would in this example be read out continuously by hardware. While having the benefit of being able to quickly restart code generation at any time in case of synchronization inconsistencies (by resetting the DSP and/or the RAM), this approach requires a high processing power (DSP), a high complexity in terms of the required hardware (DSP, RAM, a large width of the address buses to/from the RAM (depending on the maximum spreading factor to be supported and the width of each memory location]), and many DSP write cycles to initialise the RAM, i.e. to completely write the desired codeword into the RAM.

In view of the above, a code generation apparatus/method should meet the following requirements:
a) it should be capable of generating an orthogonal code having a spreading factor (length) SF and an index k, wherein the spreading factor SF is selectable from values in a range 1<SF≦SFₘₐₓ with SFₘₐₓ denoting a maximum spreading factor (according to the above, for a particular spreading factor SF, the index k can be selected from the values 0, 1, . . . , SF-1);
b) it should allow for a fast initialisation, i.e. the period of time until the first code bit is output should be minimized;
c) during code generation, it should be able to quickly restart code generation at any time, i.e. it should allow for an interruption of code generation at any time and for a fast restart of code generation beginning with the generation of the first code bit;
d) it should minimize complexity, i.e. the number of operations required in order to generate a code, or equivalently, the hardware effort necessary to be spent for this purpose. Depending on the technology used, hardware complexity can for example be expressed in terms of the processing power (of a DSP, e.g.) necessary to perform the required operations, the required number of memory locations in a RAM, the required number of logic cells on an FPGA or the size of the required area on an ASIC, the width of an address bus between different components etc.;
e) preferably, it should be able to meet the above requirements while allowing a selection of the type of orthogonal code (OVSF/Walsh/Hadamard etc.) to be generated;
f) preferably, it should be able to concurrently generate several codewords having different spreading factors SF and/or indices k (optionally: and/or types) while still meeting the above requirements.

### SUMMARY OF THE INVENTION

In view of the above, the object of the invention is to develop improved code generation apparati and methods for generating an orthogonal code (also referred to as the desired codeword) having a spreading factor SF and an index k, wherein the spreading factor SF is selectable from values in a range 1<SF≦SFₘₐₓ with SFₘₐₓ denoting a maximum spreading factor.

According to a first aspect of the present invention, this object is achieved by the code generator of claim 1. In particular, the object is achieved by the provision of (a) an index conversion unit for converting said index k (having a value in the range 0, 1, . . . , SF-1) into a modified index j associated with a corresponding code having said maximum spreading factor (so that j will be in the range 0, 1, . . . , SFₘₐₓ₋1), and (b) a logic unit for (exclusively) performing logic operations on bits of said modified index j and bits of a counter value (code bit index) i, thereby generating a code bit of said orthogonal code (desired codeword).

Equivalently, this object is achieved by the code generation method of claim 12. In particular, the object is achieved by the provision of the steps of (a) converting said index k into said modified index j, (b) initializing a counter value (code bit index) i (to zero, e.g.), (c) performing logic operations (only) on bits of said modified index j and bits of said counter value i, thereby generating a code bit of said orthogonal code, (d) incrementing said counter value i by one, and (e) repeating steps (c) and (d) until a desired number of code bits has been generated.

The conversion of the index k, which is associated with the desired codeword having a selectable spreading factor SF, to the modified index j, which is associated with said corresponding code having a fixed spreading factor, namely the maximum spreading factor, advantageously allows to reduce the complexity of the subsequent units/steps (while still keeping the selectability of the spreading factor SF), because they need to be implemented for the maximum spreading factor only. In other words, subsequent units/steps do not have to separately take into account any of the cases where SF<SFₘₐₓ.

Also, only simple logic operations are performed by the logic unit and the corresponding step, respectively, thereby eliminating the need for storing and complex processing means/steps and thus further reducing implementational complexity (no RAM/DSP/address bus necessary etc.). In addition, since neither a program needs to be executed in order to calculate the desired codeword nor any intermediate storage of the codeword is required, the overall delay caused by code generation is reduced to a significant extent so that a fast initialization as well as a quick restart of code generation becomes possible.

In summary, the features of claims 1 and 12 thus contribute to meeting the requirements (a) to (d) as described above with respect to the prior art.

As the skilled person will readily appreciate, the features of claims 1 and 12 do contribute to meeting these requirements independent from the type (OVSF, Hadamard, Walsh etc.) of orthogonal code to be generated (no matter whether fixed or selectable), and also independent from the particular realization of the index conversion and logic units (or the respective steps). In addition, the code generator of claim 1 does not necessarily include a counter for generating the counter value i, as will be seen below.

According to claims 2 and 13, said corresponding code is one of an OVSF code, a Hadamard code, and a Walsh code. In other words, the type of orthogonal code to be generated is fixed (invariant) at the input of the logic unit/prior to performing logic operations. This again contributes to further reducing complexity of the logic unit and the corresponding step (while keeping the selectability of the type of code, where appropriate), because they need to be implemented for a single type of code only while the other types are generated by appropriately converting the index k.

In summary, the features of claims 2 and 13 thus contribute to meeting the requirements (a) to (e) as described above with respect to the prior art.

Claims 3-6 and 14-17 provide advantageous implementations of the index conversion unit and the step of converting, respectively. They allow very low complexity and low delay realizations of OVSF-only (claims 3, 4, 14, 15), Hadamard-only or Walsh-only (claims 5, 16) and OVSF/Hadamard-configurable or OVSF/Walsh-configurable (claims 6, 17) code generation apparati/methods.

The skilled person will readily appreciate that other variants of the index conversion unit/step can easily be derived according to the principles described herein. For example, variants for other fixed-type (other than OVSF-only, Hadamard-only, Walsh-only) or selectable-type (other than OVSF/Hadamard-selectable or OVSF/Walsh-selectable) code generation apparati/methods can easily be derived. Also, many alternative multiplying, mapping, shifting and selecting means/steps could be considered by the person skilled in the art.

Claims 7, 8, and 18, 19 provide advantageous implementations of the logic unit and the step of performing logic operations, respectively. They allow very low complexity and low delay realizations of any kind of fixed-type (“hard-wired”) or selectable-type code generation apparatus/method, because just binary AND and/or XOR operations are performed in order to calculate a code bit of the desired codeword.

Again, it has to be stated that other variants of the logic unit and the corresponding step can easily be derived according to the principles described herein. For example, other operations can be performed so as to implement the binary addition in the combining means/step.

In view of the requirements described above, it is a further object of the invention to develop improved code generators for concurrently (simultaneously) generating p>1 orthogonal codes (also referred to as desired codewords) having respective spreading factors SF₁, . . . , SFₚ and indices k₁, . . . , kₚ, wherein the spreading factors are selectable from values in a range 1<SF₁, . . . , SFₚ≦SFₘₐₓ with SFₘₐₓ denoting a maximum spreading factor.

According to a second aspect of the present invention, this object is achieved by the parallel code generator of claim 10. In particular, the object is achieved by the provision of (a) a total of p code generators according to one of the claims 1 to 8 (i.e. not including a counter), each for generating one of said p orthogonal codes having a particular one of said spreading factors and a particular one of said indices, and (b) a counter for generating said counter value i to be used by said p code generators.

According to a third aspect of the present invention, this object is also achieved by the parallel code generator of claim 11. In particular, the object is achieved by the provision of p code generators according to claim 9 (i.e. each including a counter), each for generating one of said p orthogonal codes having a particular one of said spreading factors and a particular one of said indices.

The features of claims 10 and 11 advantageously allow to concurrently generate several (p) codewords having different spreading factors SF and/or indices k (optionally: and/or types).

According to claim 10, a single counter is provided in order to generate a counter value i to be used by all p code generators. This allows for a very low complexity implementation of the parallel code generator which can be used in cases where the p desired codewords are to be generated synchronously, i.e. where the first code bits of the codewords are to be output at the same time.

According to claim 11, each of the p code generators is provided with a dedicated counter. While increasing complexity when compared with the implementation according to claim 10, this allows for an asynchronous operation of the p code generators, where the first code bits of the codewords are not necessarily output at the same time.

In summary, the features of claims 10 and 11 thus contribute to meeting at least the requirements (a)-(d) and (f) as described above with respect to the prior art.

As the skilled person will readily appreciate, variants other than those according to claims 10 and 11 can easily be derived. For example, the counter could be split into several parts, wherein a first part could be used for all code generators (and therefore would be provided only once) while a second part of the counter could be dedicated to the p code generators (and therefore would be provided in each code generator).

According to another aspect of the present invention there is provided a computer program product directly loadable into an internal memory of a communication unit comprising software code portions for performing the inventive code generation method when the product is run on a processor of the communication unit.

Therefore, the present invention is also provided to achieve an implementation of the inventive method steps on computer or processor systems. In conclusion, such implementation leads to the provision of computer program products for use with a computer system or more specifically a processor comprised in e.g., a communication unit.

This program defining the functions of the present invention can be delivered to a computer/processor in many forms, including, but not limited to information permanently stored on non-writable storage media, e.g., read-only memory devices such as ROM or CD-ROM discs readable by processors or computer I/O attachments; information stored on writable storage media, i.e. floppy discs or hard drives; or information conveyed to a computer/processor through communication media such as network and/or telephone networks via modems or other interface devices. It should be understood that such media, when carrying processor readable instructions implementing the inventive concept represent alternate embodiments of the present invention.

### DESCRIPTION OF THE DRAWINGS

Preferred embodiments of the present invention will, by way of example, be described in the sequel with reference to the following drawings.

FIG. 1: Block diagram of a transmitter of a digital telecommunication system according to the prior art;

FIG. 2: Code tree for the generation of OVSF codes (a) and relation between OVSF and Hadamard codes (b) according to the prior art;

FIG. 3: Block diagram of a radio communication system according to the present invention;

FIG. 4: Block diagram of a transceiver in a ratio communication system according to the present invention;

FIG. 5: Block diagram of a downlink baseband modulator in a WCDMA/UMTS communication system according to the present invention;

FIG. 6: Block diagram of a code generator according to a first embodiment of the present invention;

FIG. 7: Block diagrams of exemplary index conversion units for the code generator of FIG. 6 according to the present invention;

FIG. 8: Block diagram of an exemplary logic unit for the code generator of FIG. 6 according to the present invention;

FIG. 9: Block diagram of a parallel code generator according to a second embodiment of the present invention;

FIG. 10: Flow chart of a code generation method according to the present invention;

FIG. 11: Flow charts of exemplary converting steps for the code generation method of FIG. 10 according to the present invention;

FIG. 12: Flow chart of an exemplary step of performing logic operations for the code generation method of FIG. 10 according to the present invention.

In the following description, the same reference numerals are used in order to indicate that the respective block or step has the same functionality.

### DETAILED DESCRIPTION OF THE INVENTION

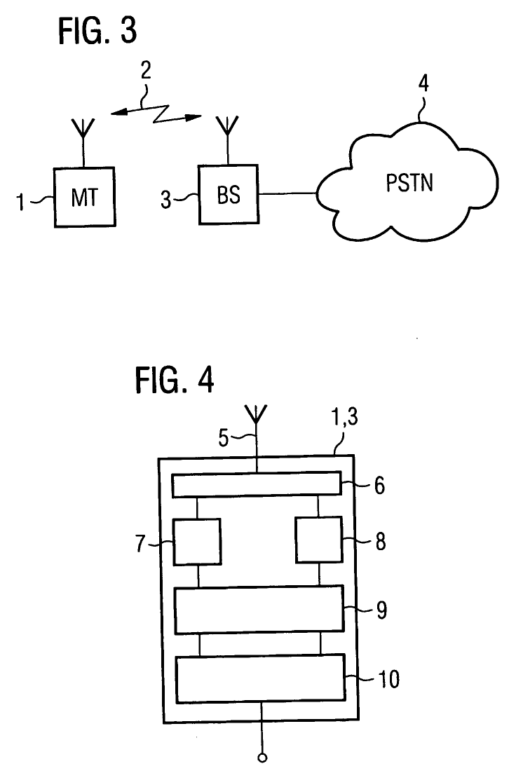

FIG. 3 shows a digital radio telecommunication system according to the invention. A typical application of such a system is to connect a mobile station or mobile terminal (MT) 1 to a core network such as the public switched telephone network (PSTN) 4. For this purpose, the mobile terminal 1 is connected to a base station (BS) 3 via a radio link 2. The radio telecommunication system provides a plurality of base stations which, through other network nodes such as controllers, switches and/or gateways (not shown) are connected to the PSTN 4. Each base station typically supports, at any one time, many radio links 2 towards different mobile terminals 1.

The radio telecommunication system shown in FIG. 3 could for instance be operated according to cellular mobile communication standards such as GSM, PDC, TDMA, IS-95, WCDMA. It should however be mentioned that the invention generally applies to digital telecommunication systems no matter whether they are radio (i.e. wireless) or wireline telecommunication systems. Moreover, the invention also applies to uni-directional (“one-way”) communication systems such as broadcasting systems.

FIG. 4 shows a block diagram of a transceiver used in mobile terminals and base stations as shown in FIG. 3. Both the mobile terminal 1 and the base station 3 are equipped with one (or several) antenna(s) 5, an antenna duplex filter 6, a radio frequency receiver part 7, a radio frequency transmitter part 8, a baseband processing unit 9 and an interface 10. In case of a base station, the interface 10 is an interface towards a controller controlling the operation of the base station, while in case of a mobile terminal, the interface 10 includes a microphone, a loudspeaker, a display etc., i.e. components necessary for the user interface.

The present invention relates to the baseband processing unit 9. The skilled person will readily appreciate that instead of transceivers each having a common baseband processing unit for both the transmission and the reception branches, in uni-directional (broadcasting) communication systems, there are transmitters each including a first baseband processing unit for the transmission branch only and separate receivers each including a second baseband processing unit for the reception branch only. The invention applies to baseband processing units for at least the transmission branch.

The person skilled in the art will also appreciate that such baseband processing units can be implemented in different technologies such as FPGA (field programmable gate array), ASIC (application specific integrated circuit) or DSP (digital signal processor) technology. In these cases, the functionality of such baseband processing units is described (and thus determined) by a computer program written in a given programming language such as VHDL, C or Assembler which is then converted into a file suitable for the respective technology.

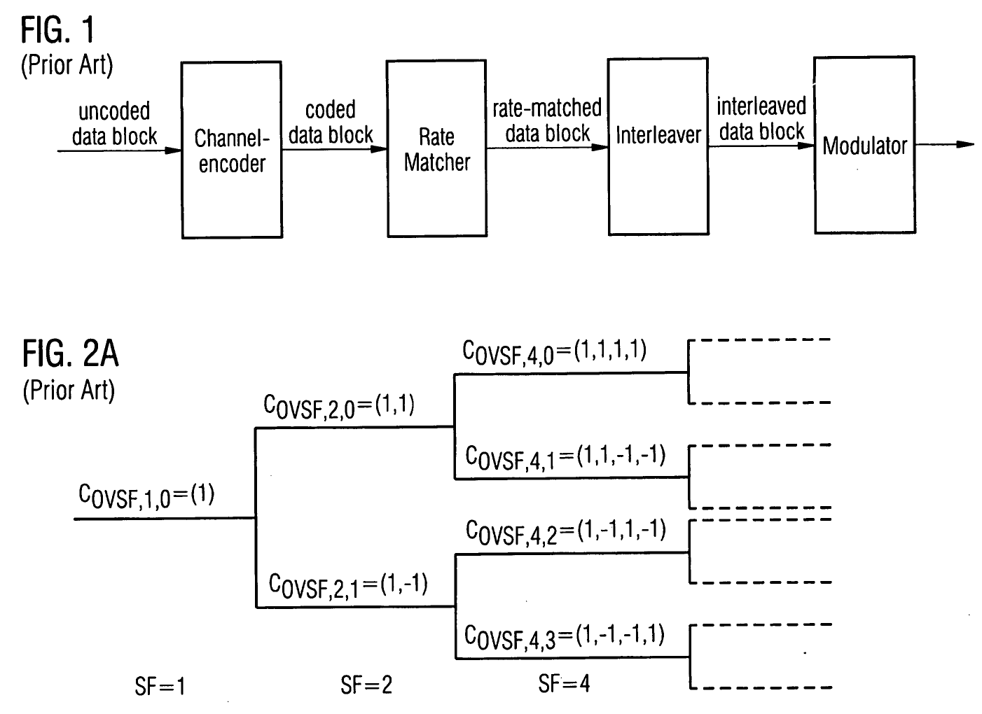

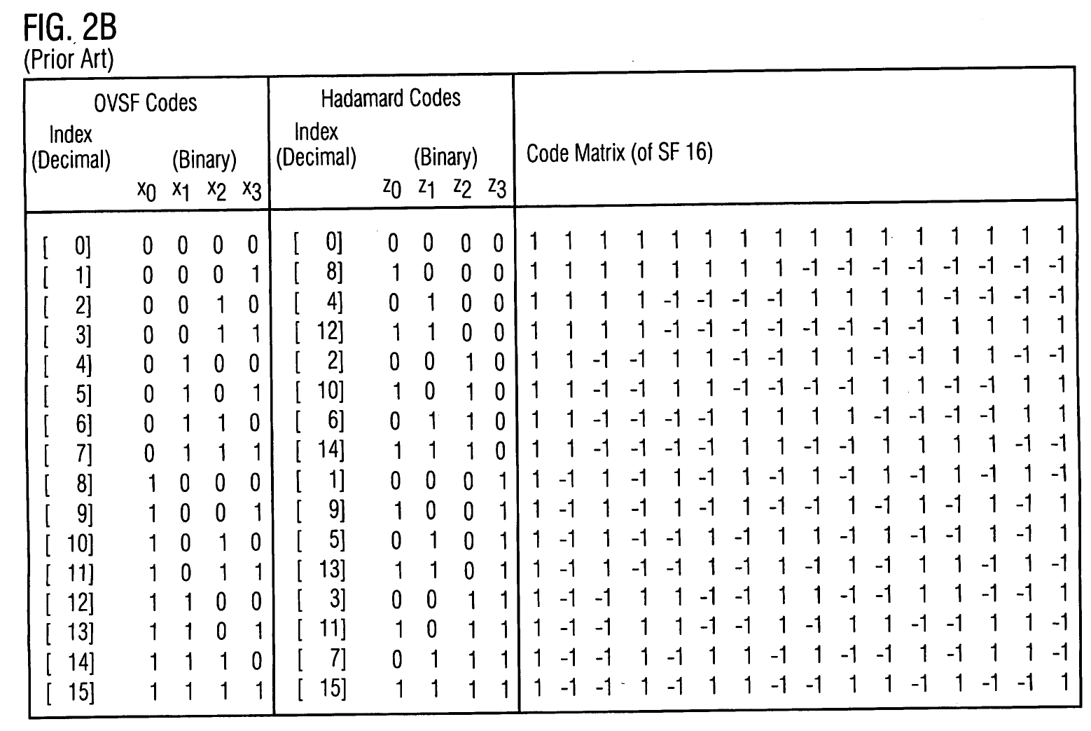

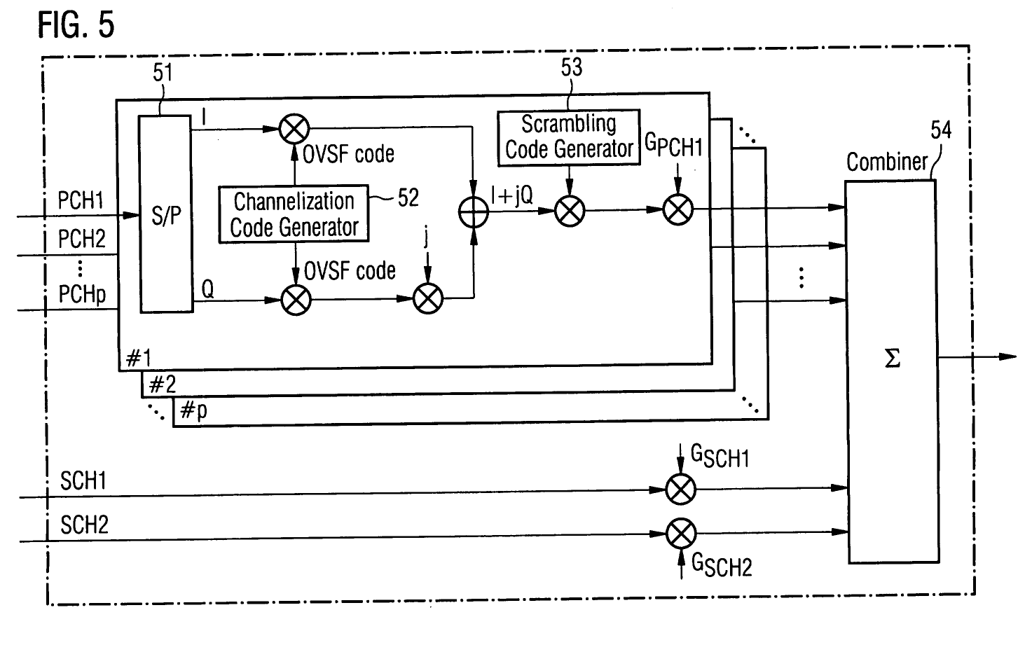

The major components of the transmission branch of the baseband processing unit 9 have already been described above with respect to FIG. 1. In particular, the baseband processing unit comprises a (baseband) modulator. FIG. 5 shows a block diagram of a downlink baseband modulator/spreader according to the WCDMA/UMTS standard. Herein, it is assumed that the output signal of the modulator/spreader will finally be transmitted at a given carrier frequency into a given sector of a cell. Such a combination of a particular sector and a particular carrier frequency (or, equivalently, frequency band), wherein both are chosen from sets of different sectors/carriers, is referred to as a “cell-carrier” in the sequel.

On the input side, FIG. 5 shows p physical channels denoted PCH1, PCH2, . . . , PCHₚ as well as two synchronization channels SCH1, SCH2. In WCDMA/UMTS systems, all physical channels except the synchronization channel are spread. Herein, spreading is achieved in two steps using different codes, the “scrambling code” and the “channelization code”. The scrambling code allows a separation of different cell-carriers, whereas the channelization code (also referred to as “spreading code”) permits a separation of different physical channels within the same cell-carrier. As shown in FIG. 5, upon a serial-to-parallel (S/P) conversion 51 of the input sequence PCH1 into in-phase (I) and quadrature phase (Q) components, spreading with the help of the channelization code is done by multiplying (in antipodal representation) the I and Q components with a real-valued OVSF code output by a channelization code generator 52. The resulting sequences of real-valued chips on the I and Q branches are then treated as a single complex-valued sequence of chips having real and imaginary parts. The complex-valued sequence (indicated by “I+jQ”) is then multiplied with a complex-valued scrambling code output by a scrambling code generator 53. An appropriate power weighting of the physical channel PCH1 is then ensured by a multiplication with a gain factor GPCH1. The same sequence of operations also applies to the other physical channels PCH2, PCH3, . . . , PCHₚ, as indicated by the frames denoted #2, . . . , #p in FIG. 5. Finally, all weighted physical channels are combined with the weighted synchronization channels in a combiner 54 in order to produce the output signal to be transmitted in a particular cell-carrier.

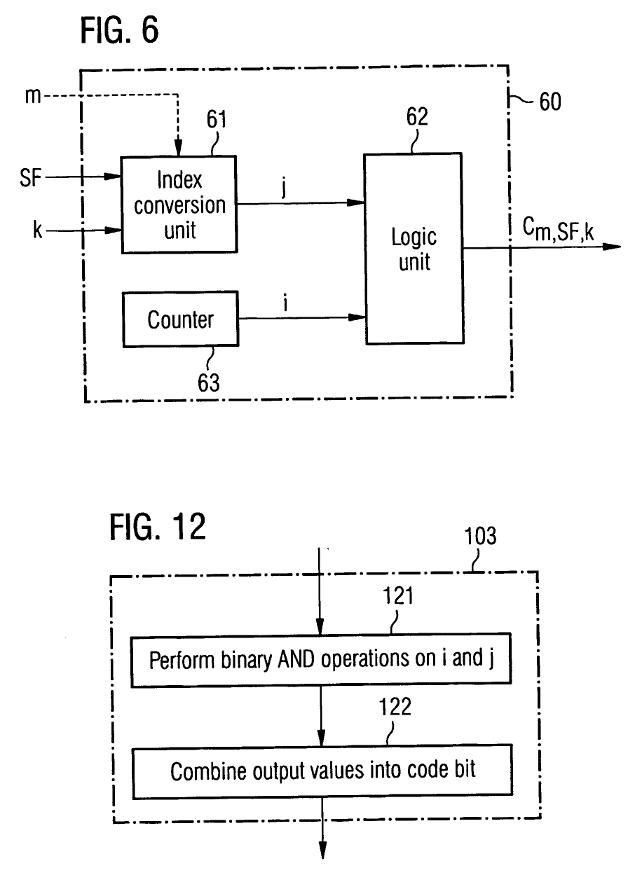

It should be noted that the number p of physical channels to be processed by a single modulator/spreader as shown in FIG. 5 may assume rather high values. Current implementations are able to process more than 1000 physical channels on a single modulator/spreader. As the skilled person will readily appreciate, this implies the presence of more than 1000 channelization code generators. For this reason, there is a strong need for efficient implementations of channelization code generators 52. Exemplary efficient implementations will be described below with respect to FIGS. 6 to 9.

While FIG. 5 applies to the downlink only, a similar block diagram holds for the uplink. In particular, the same type of channelization codes, namely OVSF codes, are used in both the downlink and the uplink. In this application, OVSF codes preserve the orthogonality between different physical channels in either the uplink or the downlink.

### First Embodiment

FIG. 6 shows a block diagram of a code generator 60 according to a first embodiment of the invention. Herein, the code to be generated (also referred to as the desired codeword) is identified by the spreading factor (length) SF and the index k, as described above with respect to the prior art. It is assumed that SF is selectable from values in the range SFₘᵢₙ≦SF≦SFₘₐₓ, wherein SFₘᵢₙ and SFₘₐₓ denote a minimum and a maximum spreading factor, respectively.

Optionally, the code generator 60 is configurable so as to generate a particular type of orthogonal code selected from a set of types including, e.g., OVSF, Hadamard, and Walsh codes. In this case, the desired type of the orthogonal code is indicated by an additional input, the mode signal m, as indicated by the dashed arrow in FIG. 6. Otherwise, the code generator 60 is suitable f or generating a single type of orthogonal code only and thus does not require a mode input.

Based on the inputs SF, k, and optionally m, the code generator 60 generates the desired codeword C_{m, SF, k} comprising SF code bits. More precisely, the desired codeword is output bit-serially (one code bit per bit period) on the output line of the code generator of FIG. 6.

According to FIG. 6, the code generator 60 includes an index conversion unit 61, a counter 63, and a logic unit 62 connected to said index conversion unit 61 and said counter 63. While the counter 63 generates a counter value i for counting (indexing) the code bits to be generated, the index conversion unit 61 receives the inputs SF, k, and optionally m, and converts the index k into a modified index j suitable for input to the logic unit 62. Based on the modified index j and the counter value i, the logic unit 62 generates the desired codeword C_{m, SF, k} by performing logic operations only (hence its name). The operations of the index conversion unit 61, and the counter 63 are controlled by a control unit not shown in FIG. 6 for conciseness reasons.

From the above, it is clear that the index k relates to the desired codeword (i.e. to the orthogonal code to be generated). In contrast, the modified index j generated by the index conversion unit 61 is associated with a corresponding code having a spreading factor equal to the maximum spreading factor SFₘₐₓ. Herein, the expression “corresponding code” refers to a particular type of orthogonal code, wherein the type is determined by the realization of the logic unit 62.

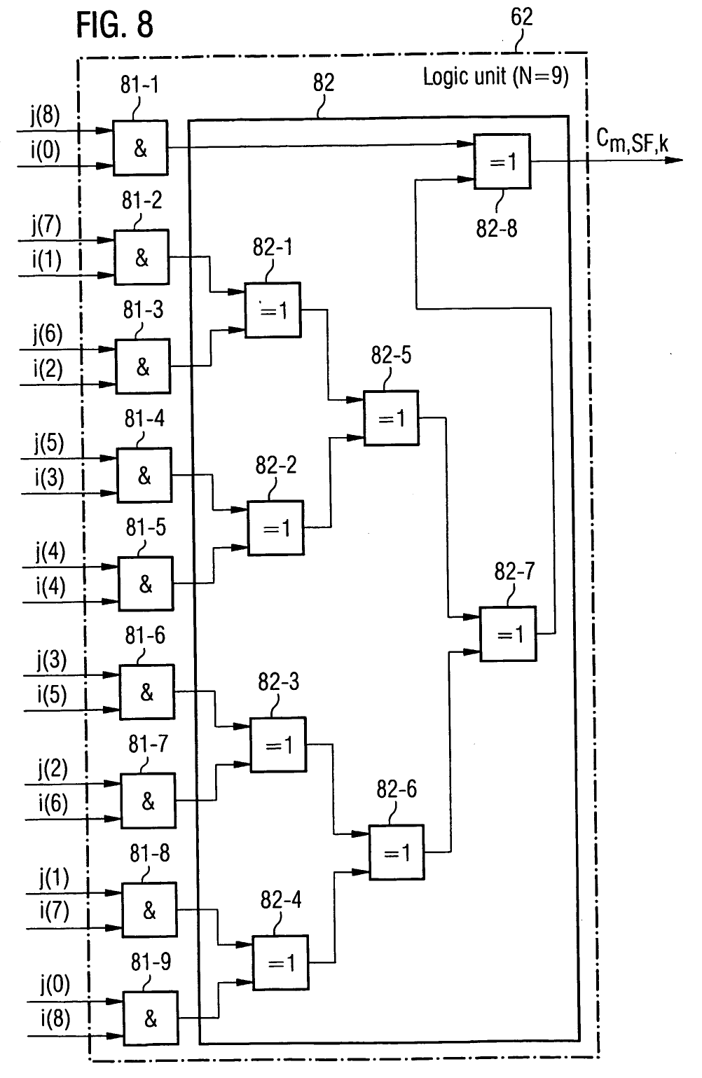

As will become apparent from the description of FIG. 8 below, the logic unit 62 of FIG. 6 is assumed to be capable of generating one particular type of orthogonal codes only (this explains why the mode signal m is not input into the logic unit 62). For example, the logic unit 62 may be capable of generating OVSF codes only. In this case, the index conversion unit 61 must be capable of generating a modified index j associated with a corresponding OVSF code having a spreading factor of SFₘₐₓ. If the code generator is to be able to deliver Hadamard and/or Walsh codes, this means that the index conversion unit 61 must be capable of converting Hadamard and/or Walsh indices k into modified indices j relating to such a corresponding OVSF code.

The logic unit 62 receives the modified index j as well as the counter value i, wherein the counter value i changes from bit period to bit period while the value of the modified index j remains constant over at least SF bit periods. Using logic operations only, the logic unit 62 in each bit period combines the bits contained in the counter value i with those contained in the modified index j in order to generate one code bit of the desired codeword. After a total of SF bit periods, the complete codeword will have been output once.

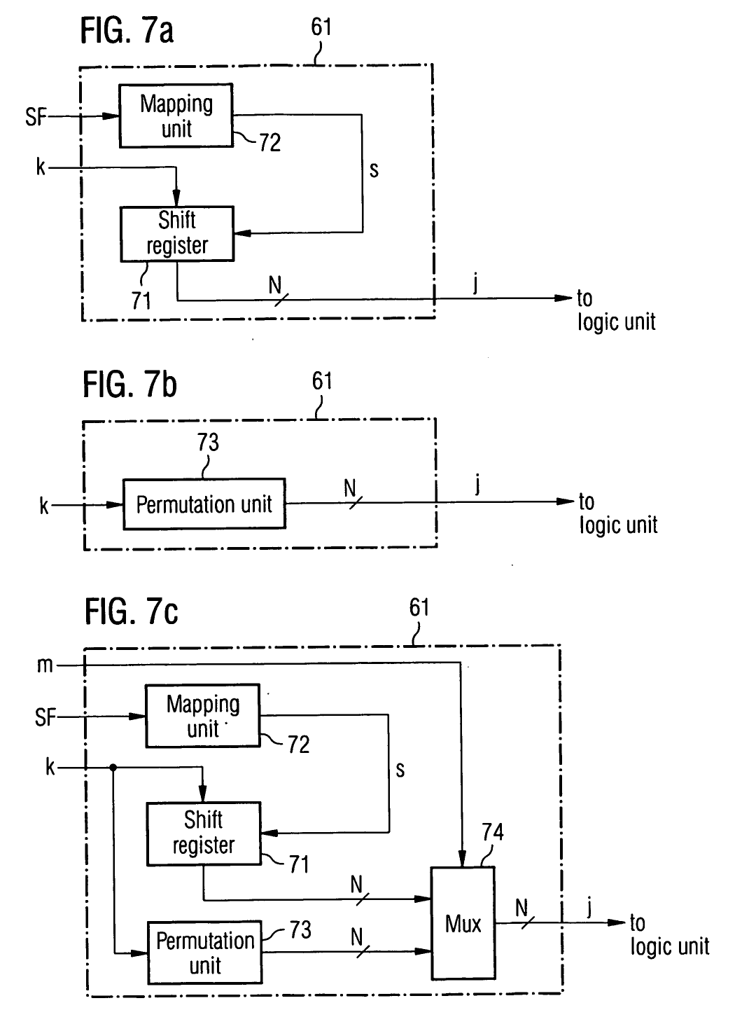

Various exemplary implementations of the index conversion unit 61 as well as the logic unit 62 will be described below with respect to FIGS. 7 and 8.

As described above with respect to the prior art, for a given spreading factor SF, there are SF different codewords C_{m, SF, k} with indices k ranging from 0 to SF-1. For this reason, a number of ld{SF} bits is required in order to represent, in binary format, the index k of a code with spreading factor SF, wherein ld{•}=log₂{•} represents the logarithm dualis (base two logarithm).

Given the assumption made above according to which the greatest selectable spreading factor is equal to SFₘₐₓ, it can thus be stated that at most
N=log₂{SFₘₐₓ}=ld{SFₘₐₓ} (1)
bits will be necessary in order to represent, in binary format, the index k of a code with SF≦SFₘₐₓ. Where less than N bits are sufficient (i.e. for SF<SFₘₐₓ) in order to represent the index k, it is assumed that leading zeros are inserted so that the index k comprises N bits independent from the actual value of SF. Note that the same number N of bits is required to represent the modified index j in binary format. In WCMDA/UMTS applications, typical values are
SFₘₐₓ=512 and thus N=ld{SFₘₐₓ}=9. (2)

Also, the counter value i generated by the counter 63 of FIG. 6 comprises N bits according to equation (1). It corresponds to the index (0, 1, 2, . . . ) of the code bits to be generated and therefore is incremented by one in each bit period. In general, for a desired codeword having a given spreading factor SF, it is sufficient for the counter 63 to count from i=0 up to SF-1 in order for the logic unit 62 to completely output the desired codeword C_{m, SF, k} comprising SF code bits. However, for SF<SFₘₐₓ, the logic unit 62 may repeat the desired codeword so that it is sequentially output SFₘₐₓ/SF times. In this case, where a total of SFₘₐₓ code bits is output independent from the actual value of SF, the counter value i is incremented from 0 up to SFₘₐₓ.

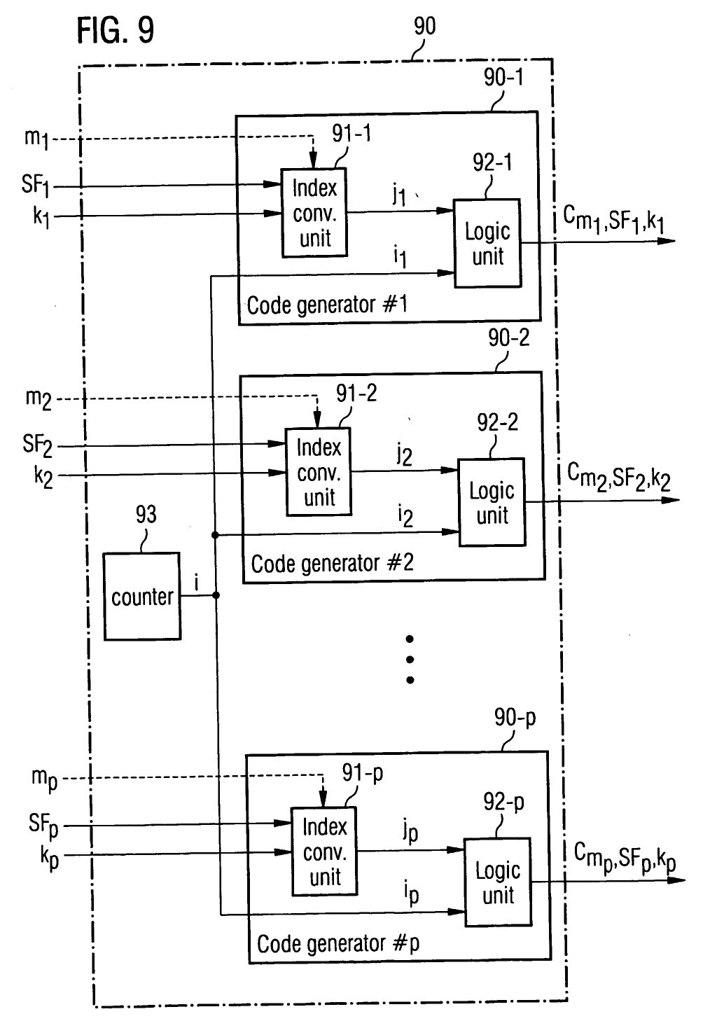

As will be described below with respect to FIG. 9, when implementing a plurality of code generators, it may be possible to fully or partially reuse the counter 63 of FIG. 6 for all code generators. When implementing a set of P>1 code generators, this would provide advantages with respect to the complexity of the hardware (in terms of the required number of FPGA cells or in terms of ASIC area, e.g.), because in this case, the counter 63 of FIG. 6 would not have to be realized P times.

In principal, the N bits forming the index k can be input serially or in parallel into the index conversion unit 61 of FIG. 6. In general, also the modified index j can be transferred serially or in parallel from the index conversion unit 61 to the logic unit 62. However, with respect to complexity and delay properties of the code generator, it is advantageous to transfer the modified index j (and also the counter value i) to the logic unit in parallel, as will be seen below from the description of FIG. 8.

When the code generator according to FIG. 6 is used in order to generate spreading/channelization codes as described above with respect to FIG. 5, the skilled person will readily appreciate that terms like “code bit”, “bit period” etc. used in the above description are equivalent to “code chip”, “chip period” etc. . . .

FIG. 7 shows block diagrams of three exemplary index conversion units 61 for the code generator of FIG. 6. Herein, FIGS. 7a and 7b refer to the case of non-configurable (“hardwired”) code generators for generating OVSF-only (FIG. 7a) and Hadamard-only (FIG. 7b) codes, respectively, whereas FIG. 7c relates to a configurable code generator suitable for generating OVSF or Hadamard codes in dependence of a mode signal m.

According to FIG. 7a (“hardwired” OVSF code generator), the index conversion unit 61 is provided with a shift register 71 and a mapping unit 72. The shift register 71 comprises N memory locations (registers) according to equation (1) each adapted to store a single bit of the index k of the OVSF code to be generated. A control input of the shift register 71 is connected to the output of the mapping unit 72 which, in turn, receives the spreading factor SF of the desired codeword as an input. The shift register 71 is further connected to the output of the index conversion unit 61 so that the modified index j can be output to the logic unit 62 of FIG. 6.

Operatively, the mapping unit 72 converts the spreading factor SF into a non-negative integer number s according to the equation
s=ld{SF_{max}-ld{SF}=ld{SF}ₘₐₓ/SF}. (3)
From this equation, it is clear that s can assume values in the range of
0≦s≦ld{SFₘₐₓ/SFₘᵢₙ}, (4)

wherein the minimum spreading factor is denoted SFₘᵢₙ. On the assumptions of SFₘₐₓ=512 and SFₘᵢₙ=4, the following table can be obtained for the values of s:

SF:

| | 4 | 8 | 16 | 32 | 64 | 128 | 256 | 512 |
|---|---|---|---|---|---|---|---|---|
| s: | 7 | 6 | 5 | 4 | 3 | 2 | 1 | 0 |

As the skilled person will readily appreciate, the mapping unit 72 can for example be realized in the form of a look-up table. Alternatively, the parameter s could be input directly into the index conversion unit and/or the code generator (in place of SF) thus rendering dispensable the mapping unit 72.

The index k of the OVSF code to be generated can be input serially or parallely into the shift register 71. Once the index k is stored in binary representation in the shift register 71, the contents of the shift register is shifted to the left (i.e. in direction of the more significant memory locations) by s memory locations (bit positions) while the rightmost s memory locations are filled with zero values. In other words, the index k is multiplied by a value of 2 to the power of s, wherein s is given by equation (3). The result of this shifting/multiplication operation is denoted modified index
j=2^{s}*k, (5)
which, just as the input index k, can in principal be output serially or parallely to the logic unit 62. In FIG. 7a, a parallel output of j is indicated on account of its implementational advantages, as will be seen below from the description of the logic unit 62.

It should be noted that this shifting/multiplication operation ensures that, independent from the actual value of SF, the most significant bit (MSB) of the index k is stored in the leftmost (MSB) memory location of the shift register 71.

It is to be noted that the multiplication of k by a factor of 2 to the power of s according to equation (5) is equivalent to a multiplication by (see equation (3))
2^{s}2^{ld{SF}^{ₘₐₓ}^{/SF}}=SFₘₐₓ/SF. (6)
For this reason, the mapping unit 72 and the shift register 71 together can be considered a multiplication means for multiplying the index k with the factor given by equation (6). As the skilled person will readily appreciate, means other than the shift register 71 and the mapping unit 72 are available in order to perform such a multiplication. For example, a processing means could perform said multiplication, wherein the factor given by equation (6) is derived from a look-up table addressed by the value of SF. Also, the shift operations could be implemented by appropriately addressing the memory locations of a storage means while determining the value of s as described above.

The effect of the multiplication according to equation (5) can be described as follows. As stated above, k is the index of the OVSF code to be generated, which otherwise is characterized by the desired spreading factor SF. In contrast, j according to equation (5) represents the index of a corresponding OVSF code having a spreading factor of SFₘₐₓ and, for SF<SFₘₐₓ, representing repetitions of an OVSF code having the desired spreading factor SF and the desired index k. In brief terms, the index k thus is converted into an index j of a corresponding OVSF code having the maximum spreading factor.

According to FIG. 7b (“hardwired” Hadamard code generator), the index conversion unit 61 is provided with a permutation unit 73 for permuting (rearranging the N bits of the index k of the desired Hadamard codeword so as to generate the modified index j. More precisely, the permutation unit 73 swaps the order of the bits, i.e. the n-th MSB of the index k becomes the n-th LSB in the modified index j, wherein n=0, 1, . . . , N-1. By this operation, the Hadamard index k is converted into an OVSF index j.

As the skilled person will readily appreciate, a rearrangement of bits similar to the one described above is required for converting the index k of a desired Walsh code into an OVSF code, or into any other type of orthogonal code. Such similar rearrangements include permutations other than just swapping the order (MSB/LSB) of bits of the index k so that, in principle, FIG. 7b also applies to “hardwired” Walsh etc. code generators.

According to FIG. 7c (configurable OVSF/Hadamard code generator), the index conversion unit 61 comprises a shift register 71, a mapping unit 72, a permutation unit 73, and a multiplexer 74 for selecting, in dependence of the mode signal m, either the output of the shift register 71 or the output of the permutation unit 73 as the modified index j to be output by the index conversion unit 61. Herein, the shift register 71, the mapping unit 72 and the permutation unit 73 have the same functionality (and input connections) as the blocks 71-73 of FIGS. 7a and 7b, respectively, and are therefore not described again. In addition to these blocks, a multiplexer 74 is provided in FIG. 7c for selecting either the permuted index output by the permutation unit 73 when the mode signal m indicates that a Hadamard code is desired, or the shifted/multiplied index output by the shift register 71 when the mode signal m indicates that an OVSF code is to be generated.

Of course, a switch for switching the index k, in dependence of the mode signal m, either to the shift register 71 or to the permutation unit 73 could be applied just as well. In this case, the output selection performed by the multiplexer 74 would be replaced with an input switching applied to the index k.

As described above with respect to FIG. 7b, the permutation unit 73 in principle applies to both Hadamard and other types of orthogonal codes (Walsh etc.). For this reason, it is obvious that, in principle, FIG. 7c not only applies to OVSF/Hadamard-configurable code generators but also to other configurable generators such as OVSF/Walsh-configurable code generators etc. . . .

As the skilled person will readily appreciate, block diagrams for other types of configurable code generators can easily be derived from FIG. 7c. For example, two different permutation units (as described above with respect to FIG. 7b) could be connected to the multiplexer 74 of FIG. 7c in order to implement a Walsh/Hadamard-configurable code generator.

Furthermore, a multiplexer (or a corresponding switch) for selecting between three or more alternatives could be used instead of the “2:1” multiplexer 74 of FIG. 7c. For example, two different permutation units as described above as well as a shift register/mapping unit (71/72) combination could be connected to the three inputs of a 3:1 multiplexer in order to implement an OVSF/Hadamard/Walsh-configurable code generator.

From the above, it follows that many other variants of “hard-wired” or configurable code generators can easily be derived by applying the principles described above with respect to FIG. 7.

FIG. 8 shows a block diagram of an exemplary logic unit 62 for the code generator of FIG. 6. In FIG. 8, it is assumed that the maximum spreading factor is 512 and thus N=9 according to equations (1) and (2).

The logic unit 62 receives the modified index j as well as the counter value i, wherein both i and j comprise N=9 bits and i corresponds to the index of the code bit to be generated (0, 1, 2, . . . ). It is assumed in FIG. 8 that the modified index j relates to an OVSF code. Other types of codes (Hadamard, Walsh etc.) can of course be generated by appropriately converting the index before it is input into the logic unit 62, as described above with respect to FIGS. 6 and 7.

Let j(N-1)=j(8) and j(0) denote the most (MSB) and least (LSB) significant bits, respectively, of the modified index j, and likewise, i(N-1)=i(8) and i(0) the MSB and LSB, respectively, of the counter value i. As can be seen from the left part of FIG. 8, the MSE. j(8) of the modified index j and the LSB i(0) of the counter value i are input into a first AND-gate 81-1 performing a binary AND operation. Likewise, j(7) and i(1), i.e. the second MSB of j and the second LSB of i, are input into a second AND-gate 81-2. In general, i.e. for arbitrary values of N, it can be stated that for n=0, 1, . . . , N-1, the bit j(N-1-n) of the modified index j is combined in the AND-gate 81-(n+1) with the bit i(n) of the counter value i. Therefore, a total of N AND-gates 81-1, 81-2, . . . , 81-N is required in order to perform the N binary AND operations, where N=9 applies to FIG. 8 as stated above. The resulting output values are then combined into a code bit of the desired codeword by a combining means, as shown in FIG. 8 by the frame 82. The combining means 82 can for example include a cascade of two-input XOR-gates 82-1, 82-2, . . . , 82-8, as shown inside said frame. However, this could of course also be achieved by a single N-input XOR-gate or any intermediate solution based on, e.g., four-input and/or two-input XOR gates etc. The complete set of XOR operations corresponds to a binary addition of the outputs of the AND-gates 81-1, 81-2, . . . , 81-N, wherein the resulting code bit is ‘1’ if the result of the binary addition is odd, while it is ‘0’ if said result is even. As the skilled person will appreciate, several alternatives are readily available in order to implement such a binary addition. Also, the exemplary logic unit 62 shown in FIG. 8 could of course be converted into its dual circuit according to principles which are well-known to the skilled person.

As stated above, FIG. 8 is based on the assumption that the modified index j relates to an OVSF code. However, as Hadamard and Walsh codes differ from OVSF codes only in so far as they are indexed differently, a minor modification could be applied to the block diagram of FIG. 8 in cases where it is desired that, for instance, the logic unit 62 is to output a Hadamard code when addressed with a Hadamard index. In its effect, this modification corresponds to the inclusion of the permutation unit 73 of FIG. 7b into the logic unit 62 of FIG. 8. As a result, for n=0, 1, . . . , N-1, the bit j(n) would have to be combined with i(n) in an AND-gate instead of combining j(N-1-n) with i(n) according to FIG. 8. For Walsh codes to be generated, a similar rearrangement of input bits has to be performed.

### Second/Third Embodiment

FIG. 9 shows a block diagram of a parallel code generator according to a second embodiment of the present invention. It is assumed that the parallel code generator 90 must be capable of generating, in the same period of time (i.e concurrently/simultaneously), a total of p>1 codewords. It should be noted that p may assume rather high values. For example, in different UMTS projects run by the applicant, p has a value of 1194 and 1636, respectively. Each codeword is identified by a spreading factor SF_{q}, an index k_{q}, and an optional mode signal m_{q} indicating the desired type of code (OVSF/Hadamard/Walsh etc.). wherein q=1, 2, . . . , p. Let SFₘₐₓ=2^{N} denote the maximum spreading factor (maximum length) of all codes to be generated, i.e.
SF_{q}≦SFₘₐₓ for q=1, 2, . . . , p.

As can be seen from FIG. 9, a set of p code generators 90-1, 90-2, . . . , 90-p is provided, wherein each code generator includes an index conversion unit 91-q as well as a logic unit 92-q (with q=1, 2, . . . p). Herein, the index conversion units 91-1, 91-2, . . . , 91-p have the same functionality as the index conversion unit 61 of FIG. 6 and can therefore be implemented as described above with respect to FIG. 7. Likewise, the logic units 92-1, 92-2, . . . , 92-p correspond in functionality to the logic unit 62 of FIG. 6 and can therefore be realized according to the principles described above with respect to FIG. 8 (for the same value of SFₘₐₓ [512] and thus N [9], the logic units can for example be identical to the one shown in FIG. 8).

Instead of providing each code generator 90-1, 90-2, . . . , 90-p with a separate counter (third embodiment, not shown in a Figure), a single counter 93 may be sufficient for all generators (second embodiment, shown in FIG. 9) if the codes to be generated are all to begin at the same instant in time (synchronous mode of operation). In this way, the complexity of the overall hardware dedicated to the generation of codes can be reduced. For architectural reasons, it may however be advantageous to split the single N bit counter 93 into, e.g., a single (N-2)-bit counter used for all generators and a further p 2-bit counters included in the p code generators, because in this case, the (N-2)-bit counter may count the code bits/chips in each symbol (in case there are 2^{N-2} chips in each symbol) while the 2-bit counters count the symbols (in case a code having the maximum spreading factor covers 4 symbol periods).

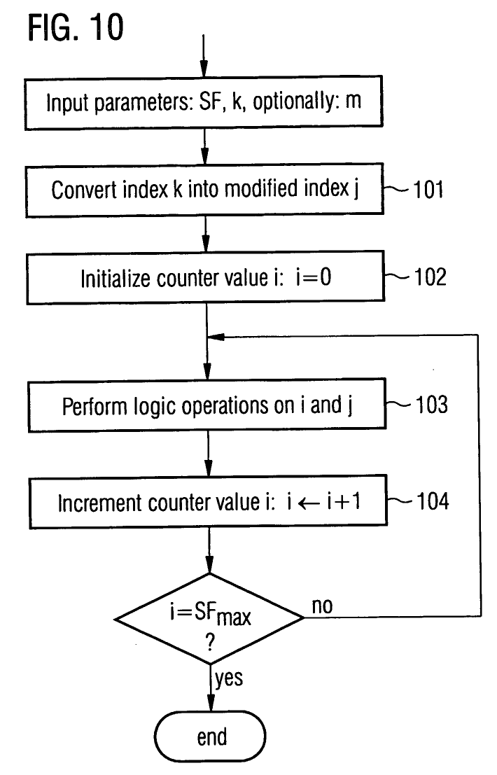

FIG. 10 shows a flow chart of a code generation method according to the present invention. Again, it is assumed that the input parameters include a spreading factor SF≦SFₘₐₓ, an index k in the range 0, 1, . . . , SF-1, and optionally, a mode signal m indicating the type of the orthogonal code to be generated (OVSF/Hadamard/Walsh etc.). In a first step 101, the index k is converted into a modified index j as described above with respect to the index conversion unit 61 in FIGS. 6 and 7. Also, a counter value i is initialized to an initialization value such as zero in a second step 102 which may be executed before, after or at the same time as step 101. Upon execution of the steps 101 and 102, in step 103, logic operations as described above with respect to FIG. 8 are performed on the bits of the counter value i and those of the modified index j in order to generate a code bit of the desired codeword. Thereafter, the ccunter value i is incremented by one in step 104. Then, it is verified whether i is equal to the desired total number of code bits to be output (which is equal to SF or SFₘₐₓ depending on whether or not the code is to be repeated). If so, the process terminates. Otherwise, the process repeats the steps 103 and 104, i.e. further code bits are generated, until i is equal to said total number.

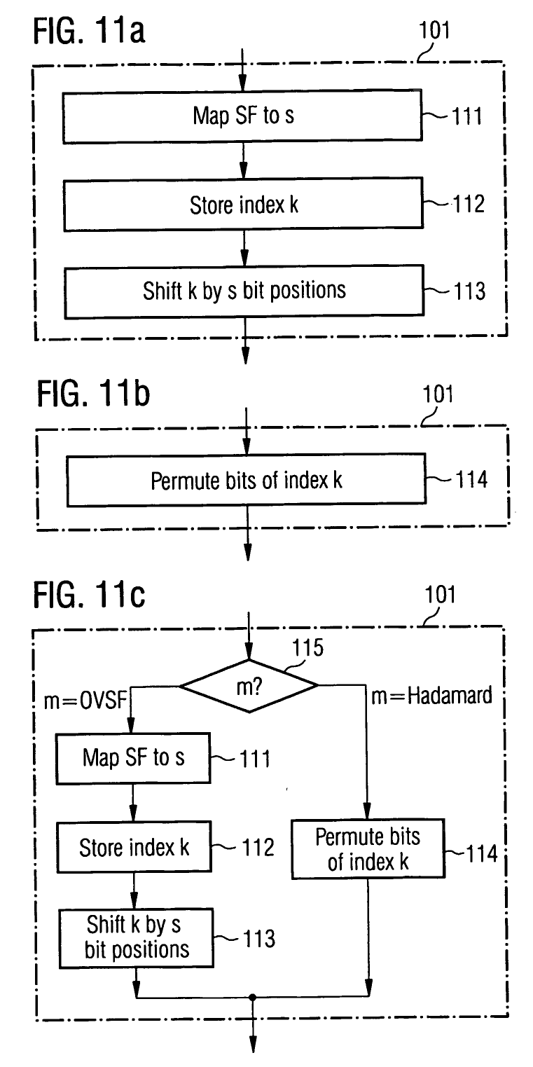

FIG. 11 shows flow charts of three exemplary index converting steps 101 for the code generation method of FIG. 10. Herein, the FIGS. 11a-c correspond to the index conversion units of FIGS. 7a-c, respectively. FIGS. 11a and 11b refer to OVSF-only (FIG. 11a) and Hadamard-only (FIG. 11b) code generation methods, respectively, whereas FIG. 11c relates to a code generation method suitable for generating OVSF or Hadamard codes in dependence of a mode signal m.

According to FIG. 11a (OVSF-only), the index converting step 101 includes a first substep 111 of mapping the spreading factor SF to the parameter s, as described above with respect to the mapping unit 72 of FIG. 7a. In a second substep 112, which may be executed before, after, or at the same time as step 111, the index k is stored, for example in a shift register as described above with respect to FIG. 7a. When both substeps have been completed, a third substep 113 of shifting the index k by s bit positions in the direction of the more significant bit positions is executed, thereby generating the modified index j (see the description of FIG. 7a).

According to FIG. 11b (Hadamard-only), the index converting step 101 includes a single substep 114 of permuting the bits of the index k as described above with respect to FIG. 7b.

According to FIG. 11c, the mode signal m is first evaluated. When m indicates that an OVSF code is to be generated, the three substeps 111-113 described above with respect to FIG. 11a are followed while the single substep 114 described above with respect to FIG. 11b is executed when a Hadamard code is to be generated.

FIG. 12 shows a flow chart of an exemplary step of performing logic operations 103 for the code generation method of FIG. 10. In a first substep 121, binary AND operations are performed on the bits of the counter value i and those of the modified index j according to the above description of the AND gates in FIG. 8. Then, in a second substep 122, the values obtained by the AND operations are combined into a code bit. This can be achieved, for example, by XOR-ing said values, as described above with respect to FIG. 8.

Further, from the description given above with respect to the present invention it is clear that the present invention also relates to a computer program product directly loadable into the internal memory of a communication unit (such as a transceiver or transmitter of a base station or a mobile phone etc.) for performing the steps of the code generation method described above with respect to FIGS. 10 to 12 in case the product is run on a processor of the communication unit.

Therefore, this further aspect of the present invention covers the use of the inventive concepts and principles for code generation within, e.g., mobile phones adapted to future applications. The provision of the computer program products allows for easy portability of the inventive concepts and principles as well as for a flexible implementation in case of re-specifications of the codes in the corresponding communication standards.

The foregoing description of preferred embodiments has been presented for the purpose of illustration and description. It is not intended to be exhaustive or to limit the invention to the precise form disclosed. Obvious modifications or variations are possible in the light of the above technical teachings. The embodiments have been chosen and described to provide the best illustration of the principles underlying the present invention as well as its practical application and further to enable one of ordinary skill in the art to utilize the present invention in various embodiments and with various modifications as are suited to the particular use contemplated. All such modifications and variations are within the scope of the invention as determined by the appended claims.

### LIST OF ABBREVIATIONS

3G: third generation
3GPP: third generation partnership project
ASIC: Application specific integrated circuit
BS: Base station
BTS: Base transceiver station
DSP: Digital signal processor
ETSI: European Telecomm. Standardization Institute
FDD: Frequency division duplex
FPGA: Field programmable gate array
GSM: Global system for mobile communications
IS-95: Interim Standard 95
LSB: Least significant bit
MSB: Most significant bit
MT: Mobile terminal/station
OVSF: Orthogonal variable spreading factor
PDC: Personal digital cellular (system)
PSTN: Public switched telephone network
RAM: Random access memory
SF: Spreading factor
TDMA: Time division multiple access
TS: Technical specification
UMTS: Universal mobile telecommunication system
WCDMA: Wideband code division multiple access

1. A code generator for generating an orthogonal code having a spreading factor (SF) and an index (k), wherein the spreading factor (SF) is selectable from values in a range 1<SF≦SFₘₐₓ with SFₘₐₓ denoting a maximum spreading factor, said code generator comprising:
an index conversion unit for converting the index (k) into a modified index (j) associated with a corresponding code having the maximum spreading factor; and
a logic unit for performing logic operations on bits of the modified index (j) and bits of a counter value (i), thereby generating a code bit of the orthogonal code.

2. The code generator according to claim 1, wherein said corresponding code is one of: an orthogonal variable spreading factor (OVSF) code, a Hadamard code, and a Walsh code.

3. The code generator according to claim 1, wherein said index conversion unit includes multiplication means for multiplying the index (k) with a value of SFₘₐₓ/SF.

4. The code generator according to claim 3, wherein said multiplication means includes:
a mapping unit for mapping the spreading factor (SF) to a number (s) equal to log₂{SFₘₐₓ/SF},
a shift register adapted to receive and store the index (k) in binary representation, further adapted to receive the number (s) and to shift the stored index (k) by (s) bit positions in the direction of more significant bit positions.

5. The code generator according to claim 1, wherein the index conversion unit includes a permutation unit for permuting the bits of the index (k).

6. The code generator according to claim 3, wherein said index conversion unit includes:
a permutation unit for permuting the bits of the index (k); and
selection means for selecting, depending upon a mode signal indicating a desired type of said orthogonal code, the output of the permutation unit or the output of the shift register, thereby generating the modified index (j).

7. The code generator according to claim 1, wherein said logic unit includes:
adding means for performing binary AND operations, wherein the adding means is adapted to receive a bit of the modified index (j) and a bit of the counter value (i), and is further adapted to output a binary output value representing a binary AND combination of the two bits; and
combining means for combining the binary output values into the code bit.

8. The code generator according to claim 7, wherein said combining means includes means for performing binary XOR operations.

9. The code generator according to claim 1, further comprising a counter for generating the counter value (i).

10. A parallel code generator for concurrently generating a number p>1 orthogonal codes having respective spreading factors (SF₁, . . . , SFₚ) and indices (k₁, . . . , kₚ), wherein the spreading factors are selectable from values in a range 1<SF₁, . . . , SFₚ≦SFₘₐₓ, with SFₘₐₓ denoting a maximum spreading factor, said parallel code generator comprising:
a number (p) of code generators, each for generating one of the p orthogonal codes having a particular one of the spreading factors and a particular one of the indices, each of said (p) code generators including:
an index conversion unit for converting the index (k) into a modified index (j) associated with a corresponding code having the maximum spreading factor; and
a logic unit for performing logic operations on bits of the modified index (j) and bits of a counter value (i), thereby generating a code bit of the orthogonal code; and
a counter for generating the counter value (i) to be used by the (p) code generators.

11. A parallel code generator for concurrently generating a number p>1 orthogonal codes having respective spreading factors (SF₁, . . . , SFₚ) and indices (k₁, . . . , kₚ), wherein the spreading factors are selectable from values in a range 1<SF₁, . . . , SFₚ≦SFₘₐₓ, with SFₘₐₓ denoting a maximum spreading factor, said parallel code generator comprising:
a number (p) of code generators, each of said code generators including:
an index conversion unit for converting the index (k) into a modified index (j) associated with a corresponding code having the maximum spreading factor;
a logic unit for performing logic operations on bits of the modified index (j) and bits of a counter value (i), thereby generating a code bit of the orthogonal code; and
a counter for generating the counter value (i);
wherein each of the code generators generates one of the (p) orthogonal codes having a particular one of the spreading factors and a particular one of the indices.

12. A method of generating an orthogonal code having a spreading factor (SF) and an index (k), wherein the spreading factor (SF) is selectable from values in a range 1<SF≦SFₘₐₓ, with SFₘₐₓ denoting a maximum spreading factor, said method comprising the steps of:
a) converting the index (k) into a modified index (j) associated with a corresponding code having the maximum spreading factor;
b) initializing a counter, value (i);
c) performing logic operations on bits of the modified index (j) and bits of the counter value (i), thereby generating a code bit of the orthogonal code;
d) incrementing the counter value (i) by one; and
e) repeating steps c) and d) until a desired number of code bits has been generated.

13. The method according to claim 12, wherein said corresponding code is one of: an orthogonal variable spreading factor (OVSF) code, a Hadamard code, and a Walsh code.

14. The method according to claim 12, wherein step a) includes multiplying the index (k) with a value of SFₘₐₓ/SF.

15. The method according to claim 14, wherein said step of multiplying includes the steps of:
mapping the spreading factor (SF) to a number (s) equal to log₂{SFₘₐₓ/SF};
storing the index (k) in binary representation in a shift register; and
shifting the stored index (k) by (s) bit positions in the direction of more significant bit positions.

16. The method according to claim 12, wherein step a) includes permuting the bits of the index (k).

17. The method according to claim 14, wherein step a) includes the steps of:
permuting the bits of the index (k); and
selecting, depending upon a mode signal indicating a desired type of the orthogonal code, the permuted index or the shifted index, thereby generating the modified index (j).

18. The method according to claim 12, wherein step c) includes the steps of:
performing binary AND operations, wherein each operation is adapted to combine a bit of the modified index (j) and a bit of the counter value (i), and to output a binary output value representing a binary AND combination of the two bits; and
combining the binary output values into the code bit.

19. The method according to claim 18, wherein said step of combining includes performing binary XOR operations.

20. (canceled)

21. A computer program product directly loadable into an internal memory of a communication unit, said product comprising software code portions that generate an orthogonal code having a spreading factor (SF) and an index (k), wherein the spreading factor (SF) is selectable from values in a range 1<SF≦SFₘₐₓ, with SFₘₐₓ denoting a maximum spreading factor, wherein, when the product is run on a processor of the communication unit, the following steps are performed:
a) converting the index (k) into a modified index (j) associated with a corresponding code having the maximum spreading factor;
b) initializing a counter value (i);
c) performing logic operations on bits of the modified index (j) and bits of the counter value (i), thereby generating a code bit of the orthogonal code;
d) incrementing the counter value (i) by one; and
e) repeating steps c) and d) until a desired number of code bits has been generated.
